(19) United States
(12) Patent Application Publication
(10) Pub. No.: US 2022/0309350 A1
(43) Pub. Date: Sep. 29, 2022

(54) SYSTEMS AND METHODS FOR ENCODING A DEEP NEURAL NETWORK

(71) Applicant: InterDigital CE Patent Holdings, SAS, Paris (FR)

(72) Inventors: Shahab Hamidi-Rad, Sunnyvale, CA (US); Swayabhoo Jain, Milpitas, CA (US); Fabien Racape, SAN FRANCISCO, CA (US)

(21) Appl. No.: 17/621,378

(22) PCT Filed: Jun. 26, 2020
(86) PCT No.: PCT/IB2020/000566

§ 371 Date: Dec. 21, 2021

Related U.S. Application Data
(60) Provisional application No. 62/869,680, filed on Jul. 2, 2019.

(51) Int. Cl. G06N 3/08; G06N 3/04

(52) U.S. Cl. CPC G06N 3/082; G06N 3/04

(57) ABSTRACT

The present disclosure relates to a method including encoding a data set in a signal, the encoding comprising quantizing the data set by using a codebook obtained by clustering the data set, the clustering taking account of a probability of appearance of data in the dataset; the probability being bounded to a bounding value. The present disclosure also relates to a method including encoding in a signal a first weight of a layer of a Deep Neural Network, the encoding taking into account an impact of a modification of a second weight on an accuracy of the Deep Neural Network. The present disclosure further relates to the corresponding signal, decoding methods, devices, and computer readable storage media

This application claims the benefit of U.S. Patent Application No. 62/869,680 filed on 2 Jul. 2019

### 1. FIELD

The domain technical field of the one or more embodiments of the present disclosure is related to data processing, like for data compression and/or decompression. For instance, at least some embodiments relate to data compression/decompression involving huge number of data, like compression and/or decompression of at least a part of a video stream, or like compression and/or decompression of data in link with a use of Deep Learning techniques, like a use of a Deep Neural Network (DNN) or image and/or video processing, like processing including image and/or video compression. For instance, at least some embodiments further relate to encoding/de-coding a Deep Neural Network.

### 2. BACKGROUND

Deep Neural Networks (DNNs) have shown state of the art performance in variety of domains such as computer vision, speech recognition, natural language processing, etc. This performance however can come at the cost of massive computational cost as DNNs tend to have a huge number of parameters often running into millions, and sometimes even billions.

There is a need for a solution to facilitate transmission and/or storage of parameters of a DNN.

### 3. SUMMARY

At least some embodiments of the present disclosure enable at least one disadvantage to be resolved by proposing a method comprising encoding a data set in a signal, said encoding comprising quantizing said data set by using a codebook obtained by clustering said data set, said clustering taking account of a probability of appearance of data in said dataset. According to at least some embodiments of the present disclosure; said probability is bounded to at least one bounding value.

At least some embodiments of the present disclosure enable at least one disadvantage to be resolved by proposing a method for encoding at least one first weight of at least one layer of at least one Deep Neural Network. According to at least some embodiments of the present disclosure; said encoding takes into account an impact of a modification of at least one second of said weights on an accuracy of said Deep Neural Network.

For instance, at least one embodiment of the method of the present disclosure relates to quantization and entropy coding of a Deep Neural Network.

At least some embodiments of the present disclosure enable at least one disadvantage to be resolved by proposing a method comprising decoding a data set in a signal, said decoding comprising an inverse quantizing using a codebook obtained by clustering said data set, said clustering taking account of a probability of appearance of data in said dataset.

According to at least some embodiments of the present disclosure; said probability is bounded to at least one bounding value.

At least some embodiments of the present disclosure relate to a method for decoding at least one first weight of at least one layer of at least one Deep Neural Network. For instance, at least one embodiment of the method of the present disclosure relates to entropy decoding and de-quantization of a Deep Neural Network.

According to at least some embodiments of the present disclosure; said first weight has been encoded by taking into account an impact of a modification of at least one second of said weights on an accuracy of said Deep Neural Network.

According to another aspect, there is provided an apparatus. The apparatus comprises a processor. The processor can be configured to encode and/or decode a deep neural network by executing any of the aforementioned methods.

According to another general aspect of at least one embodiment, there is provided a device comprising an apparatus according to any of the decoding embodiments; and at least one of (i) an antenna configured to receive a signal, the signal including a video block, (ii) a band limiter configured to limit the received signal to a band of frequencies that includes the video block, or (iii) a display configured to display an output representative of a video block.

According to another general aspect of at least one embodiment, there is provided a non-transitory computer readable medium containing data content generated according to any of the described encoding embodiments or variants.

According to another general aspect of at least one embodiment, there is provided a signal comprising data generated according to any of the described encoding embodiments or variants.

According to another general aspect of at least one embodiment, a bitstream is formatted to include data content generated according to any of the described encoding embodiments or variants.

According to another general aspect of at least one embodiment, there is provided a computer program product comprising instructions which, when the program is executed by a computer, cause the computer to carry out any of the described decoding embodiments or variants.

### 4. BRIEF DESCRIPTION OF THE DRAWINGS

FIG. 1 shows a generic, standard encoding scheme.

FIG. 2 shows a generic, standard decoding scheme.

FIG. 3 shows a typical processor arrangement in which the described embodiments may be implemented.

FIG. 4a illustrates PDF placement using PDF-based initialization method.

FIG. 4b illustrate respectively CDF placement using PDF-based initialization method.

FIG. 4c illustrates cluster placement using PDF-based initialization method.

FIG. 5a illustrates PDF placement using at least some embodiment of the Bounded-PDF method of the present disclosure.

FIG. 5b illustrates CDF placement using at least some embodiment of the Bounded-PDF method of the present disclosure.

FIG. 5c illustrates initial cluster placement using at least some embodiment of the Bounded-PDF method of the present disclosure.

It is to be noted that the drawings illustrate example embodiments and that the embodiments of the present disclosure are not limited to the illustrated embodiments.

### 5. DETAILED DESCRIPTION

A first aspect of the present disclosure concerns cluster initialization (called “Bounded PDF” initialization hereinafter). This first aspect is detailed hereinafter in an exemplary embodiment relating to the compression of a least a part of a Deep Neural Network. However, this first aspect can be applied in many other embodiments related to other technical fields (for instance image and/or video processing).

The first aspect is described hereafter in link with exemplary embodiments based on the K-Means algorithm. Of course, other embodiments of the method of the present disclosure can rely on another algorithm.

According to a second aspect, the present disclosure proposes a compression framework of at least a part of a DNN which utilizes a gradient based importance metric. it is to be understand that those two aspects can be implemented independently. For instance, in some embodiments of the present disclosure, the compression of a DNN using an importance metric can be performed without a cluster initialization as described in link with the first aspect of the present disclosure (for instance using a non-bounded linear initialization of the clusters).

It is to be pointed out that the present disclosure encompasses embodiments implementing the first aspect of the present disclosure but not the second aspect, embodiments implementing the second aspect of the present disclosure but not the first aspect, and embodiments implementing both the first and the second aspects of the present disclosure.

The huge number of parameters of Deep Neural Networks (DNNs) can lead for instance to prohibitively high inference complexity. Inference complexity can be defined as the computational cost of applying trained DNN to test data for inference.

This high inference complexity can thus be an important challenge for using DNNs in environments involving an electronic device with limited hardware and/or software resource, for instance mobile or embedded devices with resource limitations like battery size, limited computational power, and memory capacity etc.

At least some embodiment of the present disclosure applies to compression of at least one DNN, so that can facilitate transmission and/or storage of the at least one DNN.

In at least one embodiment of the present disclosure, performing a compression of a Neural Network can comprise:

Quantization of parameters (like Weights and Biases) of the Neural Network to represent them with a smaller number of bits.

Lossless entropy coding of the quantized information.

In some embodiments, the compression can further comprise, prior to the quantization, a step of reducing the number of parameters (like Weights and Biases) of the Neural Network by utilizing the inherent redundancies in the Neural Network. This step is optional.

At least one embodiment of the present disclosure proposes innovative solutions for performing the above quantization step and/or the lossless entropy coding step.

An exemplary embodiment of the method of the present disclosure relates to an initialization for the K-Means algorithm, for instance for clustering data relating to a Deep Neural Network. The initialization of the K-Means algorithm can be based, for instance, on a combination of

Linear and Density-based methods. Such an initialization of the K-Means can help improving the performance of K-Means algorithm for quantization.

K-Means is a simple algorithm for clustering n-dimensional vectors. For instance, in exemplary embodiments relating to a compression of a DNN, the K-Means algorithm can be used for the quantization of the network parameters. The goal of K-Means algorithm is to partition data that are similar into “k” well-separated clusters. In quantization context, the number k can be a power of 2. The group of clusters is referred to hereinafter as the “Codebook”. Each entry in the codebook is a number specifying the “center” of that cluster. For example, for 5-bit quantization of numbers, the codebook has 2⁵=32 entries and each number can be represented by a 5-bit index value that corresponds to the codebook entry that is closest to this number.

In the context of neural network compression, we can quantize each weight or bias matrix separately as a single dataset of scalar numbers in 1-dimensional space.

We note as W={w₁, . . . , wₙ} the set of all weight values in a matrix, and as C=(C₁, . . . , Cₖ) the collection of k clusters partitioning the values of W. In at least one embodiment of the present disclosure, with this notation, our goal is to minimize the equation:

$$C = {arg min}_{{c}_{1} , … , {c}_{k}} {\sum }_{i = 1}^{k} {\sum }_{w ∈ {C}_{i}} {\vert w - {c}_{i} \vert}^{2} \qquad ( 1 )$$

Where cᵢ (with c in lower case) is the center of i′th cluster Cᵢ (with C in upper case).

Therefore, in at least one embodiment of the present disclosure, the output of quantization process for each matrix is a codebook C and a list of m-bit index values (where m=log₂ k); one for each number in the original matrix.

The output of the quantization process can further be compressed using a lossless entropy coding algorithm, such as Huffman or Arithmetic Coding. The arithmetic coding can help to obtain (e.g. provide)a higher compression efficiency in at least some embodiments.

Cluster Initialization

A first aspect of the present disclosure relates to cluster initialization.

For instance, in case of clustering based on a K-Means algorithm, the present disclosure relates to initialization of the K-Means algorithm.

Cluster initialization can impact the performance of the K-Means algorithm and quantization process. Therefore, cluster initialization can play an important role in improving network accuracy. Initialization of a K-Means clustering algorithm can be based for instance on random

Initialization. Random initialization can be done for instance by just choosing k samples from our dataset (the numbers in the weight matrix) randomly and use them as initial clusters. Alternatively, Random initialization can be done by choosing k values randomly between the minimum (min) and maximum (max) values of the numbers in the dataset (thus in the range [min, max]). However, our experiments suggest that this can cause problems for some outlier values which occurs in the dataset with low probability. Also, this could result in poor selection of cluster centers in a way that it is impossible to recover from during the K-Means algorithm.

In a variant, Probability Density Function (PDF) based Initialization can be used for the initialization of a K-Means clustering algorithm. PDF based Initialization is similar to random initialization, but it gives more importance to the numbers with higher probability of appearance in the dataset. One easy way to consider PDF is calculating the Cumulative Density Function (CDF) of the dataset, then linearly space the y-axis and find the corresponding x values as the initial cluster center. This makes the centers denser around the values with higher probability and more scattered around the values with lower probability.

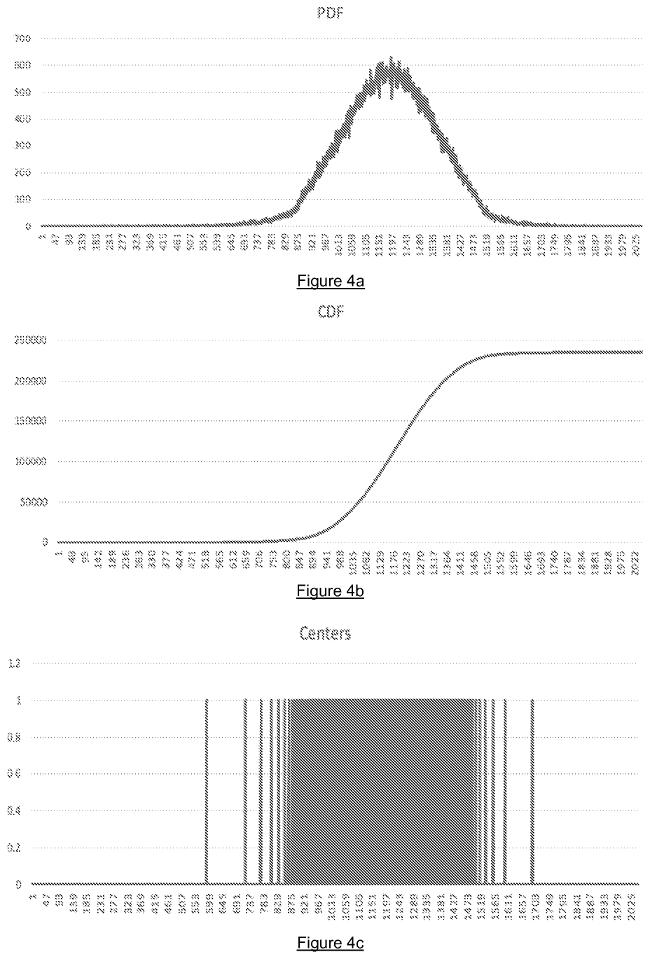

FIGS. 4a, 4b and 4c illustrate respectively PDF, CDF, and cluster placement using PDF-based initialization method. More precisely, FIG. 4a shows PDF of weight values for an exemplar layer (herein a fully connected layer) of an exemplar neural network. The PDF was obtained using a 2048-bin histogram of the original weight values. The x-axis represents the parameter values and the y-axis represents the number of occurrences of the parameter values. FIG. 4b shows CDF calculated using the above PDF chart, and FIG. 4c shows placement of PDF-based initial cluster centers. As illustrated by FIGS. 4a, 4b and 4c, the cluster centers are denser in the middle where the PDF is large, but there are almost no placements at both ends of the graph where PDF is small.

Although PDF based Initialization can show better precision for the numbers with high probability than Random Initialization, PDF based Initialization can sometimes result in poor approximation for some weights with lower probability, which in practice can degrade the performance of quantization.

In another variant, Linear Initialization can be used for the initialization of a K-Means clustering algorithm. Linear Initialization simply initializes the cluster centers linearly between [min, max] of the dataset values (spaced evenly). Linear Initialization can sometimes give better results for at least some low probability values than Random and/or PDF based Initialization. However, Linear Initialization can sometimes be less efficient than the PDF based initialization for at least some high probability values.

At least some embodiments of the present disclosure propose to use a method of initialization called hereinafter “Lower-bounded PDF initialization”, by clipping the PDF function with a lower bound. More precisely, we bump up the probability density of at least some of the values whose probability of appearance in the dataset is smaller than a first low bound, like a predefined low bound.

For instance, in some exemplary embodiments, we bump up the probability density of all the values whose probability of appearance in the dataset is smaller than a first lower bound. At least some embodiments of the Lower-bounded PDF initialization method can help giving good granularity of the cluster centers around at least some of the high-probability values while assigning enough cluster centers around at least some of the values occurring with low probability.

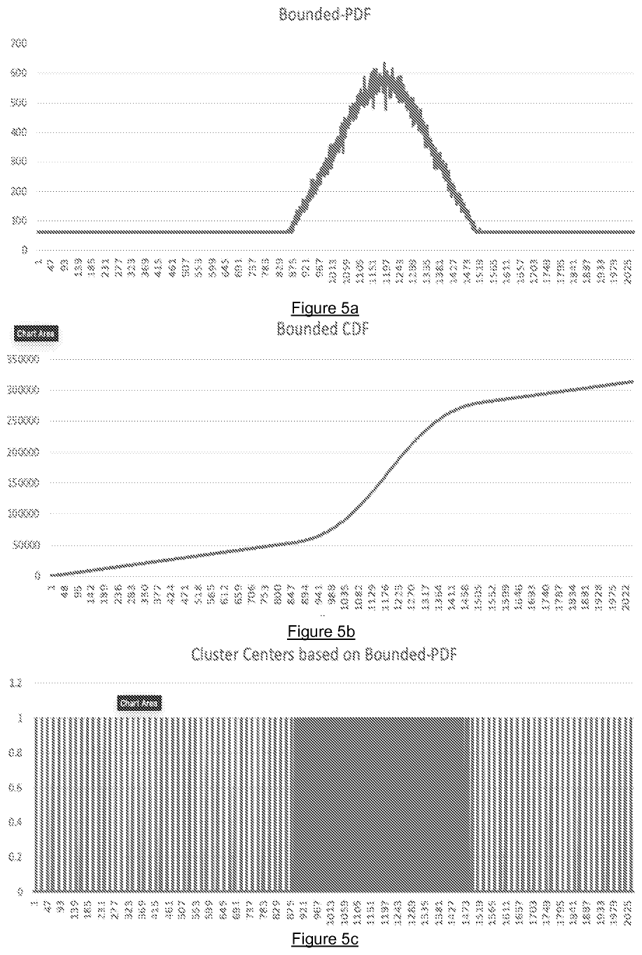

FIGS. 5a, 5b and 5c illustrate respectively PDF, CDF, and initial cluster placement using our Bounded-PDF method. More precisely, FIG. 5a shows Bounded-PDF of weight for an exemplar layer (herein a fully connected layer) of an exemplar neural network. This was obtained using a 2048-bin histogram of the original weight values. The PDF values were then clipped at 10 percent of the peak value. FIG. 5b shows the Bounded-CDF calculated using the above PDF chart. FIG. 5c shows placement of initial cluster centers based on our Bounded-PDF method. As illustrated by FIGS. 5a, 5b and 5c, the cluster centers are denser in the middle where the PDF is large and there are also enough cluster placements at both ends of the graph where PDF is small.

### A Gradient-Base Measure for Importance of Network Parameters

According to a second aspect, the present disclosure proposes a compression framework for DNN, which utilizes a gradient based importance metric.

According to the second aspect, at least one embodiment of the present disclosure provides a Gradient-base measure of importance of network parameters, like values in a weight/bias matrix. As an exemplar, at least one embodiment of the present disclosure associates an “Importance” metric to at least one value in a weight/bias matrix.

For instance, according at least one embodiment of the present disclosure, the importance metric can be used for quantization.

According at least one embodiment of the present disclosure, the importance metric can be used for entropy coding.

A least one embodiment of the present disclosure uses the importance metric to help improving the K-Means Algorithm for quantization.

At least one embodiment of the present disclosure uses the importance metric to help improving arithmetic coding.

More precisely, a measure of an importance I, of a weight w of a matrix corresponding to a layer of a deep Neural Network is defined. This importance measure lw, also called herein importance metric, is representative of the impact of modifications of the weight w on the network accuracy.

The training of deep neural networks can involve defining a loss function and trying to minimize the loss function by modifying network parameters (like Weights and Biases of network layers) using a back-propagation process. For example, in case of supervised training of a neural network, the loss function can be the mean squared error between the network output and the actual labels of the training dataset.

The process of training a DNN can result in an updated set of network parameters for different layers of the network that minimizes the loss function over the entire training dataset. The updated set of network parameters can be referred to as an optimized set of network parameters.

Once a network is trained, any modification of network parameters can result in degraded performance of the network (i.e. lower accuracy). However, the impact of modifications of different network parameters on the performance of the network can differ upon parameters. In other words, for some network parameters a small change can have a big impact on the accuracy while the same amount of change in other parameters may have smaller impact on the accuracy (small or even no effect on the network performance).

The importance measure I_{w} of a weight w is representative of the impact of modifications of the weight won the network accuracy.

The process of quantization modifies the values of network parameters by replacing them with an index to the corresponding entry in the codebook. For instance, for quantization by clustering, each weight value w changes to the value c, where c, is the cluster center for that weight. This means each weight value w is subject to a modification equal to |w−cᵢ|.

As an exemplar, as mentioned earlier, the K-Means algorithm uses equation (1). This equation tries to minimize the difference between the values and the cluster centers within each cluster. In other words, we try to minimize (or at least decrease) the total amount of modifications |w31 cᵢ| to all weight values.

According to at least one embodiment of the present disclosure, where an importance measure lw of a weight w proportional to the impact of modifications of the weight on the network accuracy can be obtained, the K-Means clustering algorithm can thus be modified so that the changes to the weight values are inversely proportional to their importance measure. This can result in the cluster centers c, to be closer to the more important weight values (the ones with highest l_{w} values).

As explained above, the changes in accuracy of a network can be very closely related to the changes in the loss function. Therefore, the importance measure of a weight can be defined as the ratio of the changes in the value of loss function with the changes in the weight value. For instance, to calculate the importance values, we can feed the network (being for instance a trained network) with training samples and we can add up the absolute values of the gradients of loss function with respect to every network parameter, or more formally:

$${I}_{{w}_{j}} = {\sum }_{x ∈ {X}_{training}} \vert \frac{\partial L ( W , x )}{\partial {w}_{j}} \vert \qquad ( 2 )$$

Where W is the set of all parameters (weight values) of the trained network, L is the loss function which depends on network parameters (the weight values) and the input sample x taken from training samples, wⱼ is one of the parameters of W and Iwⱼ is the importance measure of wⱼ.

This means that if a measure of importance I_{w} is close to zero for a weight value w, small modification to this weight value have little or no impact on the performance of the network. In other words, we can move the corresponding cluster center away from this value and closer to more important weight values (With higher measure of importance).

It is to be pointed out that in some embodiments, the training samples can be the samples of the training set already used for training the network and a subset of this training set . Weighted K-means

At least one embodiment of the present disclosure uses the importance metric defined above to help improving the K-Means Algorithm for quantization.

In the exemplary embodiment detailed above, the original K-Means algorithm uses the equation (1) to optimize the clustering. Utilizing the importance metric defined above (like (2)), we can modify this equation to optimize the clustering more efficiently for the values in the weight matrix of at least one layer of the network. We call the new clustering algorithm “Weighted K-Means” and define the optimization problem as:

$$C = {arg min}_{{c}_{1} , … , {c}_{k}} {\sum }_{i = 1}^{k} \frac{{\sum }_{w ∈ {c}_{i}} {I}_{w} \cdot {\vert w - {c}_{i} \vert}^{2}}{{\sum }_{w ∈ {c}_{i}} {I}_{w}} \qquad ( 3 )$$

This means the center of each cluster can be obtained by weighted average of its members using the importance measures as the averaging weights:

$${c}_{i} = \frac{{\sum }_{w ∈ {c}_{i}} {I}_{w} \cdot w}{{\sum }_{w ∈ {c}_{i}} {I}_{w}} \qquad ( 4 )$$

### Arithmetic Coding Using the Importance Measure

According to at least one embodiment of the present disclosure, the importance metric can be used for entropy coding, for instance for arithmetic coding.

The lossless compression with entropy coding works based on the fact than any data can be compressed if some data symbols are more likely to happen than others. For instance, for the best possible compression code (minimum average code length) the output length contains a contribution of “-log p” bits from the encoding of each symbol whose probability of occurrence is p.

Thus, at least one embodiment of the present disclosure takes account of probability of occurrence of at least one of the data symbols. As an exemplar, at least one embodiment of the present disclosure takes account of a probability model of occurrence for all the data symbols. Indeed, having an accurate probability model of occurrence of all the data symbols can be help for the success of the arithmetic coding.

In the exemplary case of neural network compression, the probability model can be obtained from the output of the quantization stage. For instance, in at least one embodiment of the present disclosure, obtaining the probability model can comprise counting the number of times each item in the codebook is referenced in the original data.

The average optimal code length for symbols produced by a given probability model can be given by the entropy:

$$H = - {\sum }_{i = 1}^{k} {p}_{i} {log}_{2} {p}_{i}$$

Where pᵢ is the probability of the i′th entry in the codebook with k entries.

According to at least one embodiment of the present disclosure, the code length above can be reduced when there are larger differences in the probabilities of different symbols in the codebook. Such an embodiment can help improving entropy coding. More precisely, at least one embodiment of the present disclosure comprises modifying the codebook probabilities and making it more “unbalanced”. This is referred to herein as “Cluster Migration”. Cluster Migration can comprise moving some weight with low importance measure to the neighboring clusters to amplify cluster population gap.

First, a list of weights having an importance measure smaller than a specified importance margin Iₘᵢₙ is created. Then for every item in this list, we consider m_{neighbors} nearest clusters in terms of weight value, including current cluster, and move the weight to the cluster with the highest population among the m_{neighbors} nearest clusters.

In our experiments, cluster migration has improved efficiency of arithmetic coding by %15 to %20 without any impact on the network performance.

Note that while arithmetic coding itself is a lossless process, the “Cluster Migration” process is not. This is because we are actually changing the values of the weights by moving them to a different cluster. That is why choosing the right value for Iₘᵢₙ and M_{neighbors} can be very important. Poor selections of these parameters could impact the network performance.

Depending upon embodiments of the present disclosure, importance measure detailed above can be used for quantization and/or entropy coding of weights of at least one layer of a neural network (for instance one layer, two layers, all layers of a same type, all layers). For instance, the importance measure can be used for instance for quantization and/or entropy coding of at least some weights of at least one convolutional layer and/or at least one fully connecter layer. In some embodiments, importance measure can be used for quantization but not for entropy coding, or vice-versa, or for quantization of at least some weights of one layer and for entropy coding regarding at least some weights of another layer.

Experimental Results

Some experimental results are detailed below for an exemplary embodiment based on an Audio Classification neural network (One of MPEG NNR use cases) with the following network configuration.

AudioTest Layers Information:

| Index | Layer Type | In Shape | Details | Out Shape | Activation | Params |
|---|---|---|---|---|---|---|
| 0 | CONV + MP | [80, 80, 1] | 3 × 3 × 16/2 − V | [39, 39, 16] | None | 160 |
| 1 | FC | 24336 | | 256 | Sigmoid | 6230272 |
| 2 | FC | 256 | Output Layer | 1 | Sigmoid | 257 |

Total Number of parameters: 6230689

We first reduce the number of parameters in layer of index 1 from 6230272 to 49440 (Using a method for compression of a Deep Neural Network described in US patent application 62818914) This gives us the following network structure:

Audio Test Layers Information:

| Index | Layer Type | In Shape | Details | Out Shape | Activation | Params |
|---|---|---|---|---|---|---|
| 0 | CONV + MP | [80, 80, 1] | 3 × 3 × 16/2 − V | [39, 39, 16] | None | 160 |
| 1 | LR2 | 24336 | r = 2 | 256 | Sigmoid | 49440 |
| 2 | FC | 256 | Output Layer | 1 | Sigmoid | 257 |

Total Number of parameters: 49857 (As explained above reducing of the number of parameters is optional and can be omitted)

Then we compress the network using Regular Quantization and Entropy Coding (first results) and, alternatively, according to at least some of the methods of the present disclosure, using the clustering initialization and the importance measure for arithmetic coding described above (second results).

The experiment leads to the following results:

### Original Model:

Number of Parameters: 6,230,689
Model Size: 74,797,336 bytes
Accuracy: 0.826190
   Using Regular Quantization and Entropy Coding, with no clustering initialization (first results):
   Number of Parameters: 49,857
   Model Size: 30,672 bytes
   Accuracy: 0.830952
      Using Quantization and Entropy Coding with clustering initialization and using importance measure for arithmetic coding described above (second results):

Number of Parameters: 49,857

Model Size: 24,835 bytes

Accuracy: 0.826190

One can see that the model size of the second results (using clustering initialization and using importance measure for arithmetic coding) are about 3012 times smaller than the original model (%99.97 compression), is also about %21 percent smaller compared to the model size of the first result of Regular Quantization and Entropy Coding.

No changes in accuracy occurs compared to the original model.

### Additional Embodiments and Information

This application describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

The aspects described and contemplated in this application can be implemented in many different forms.

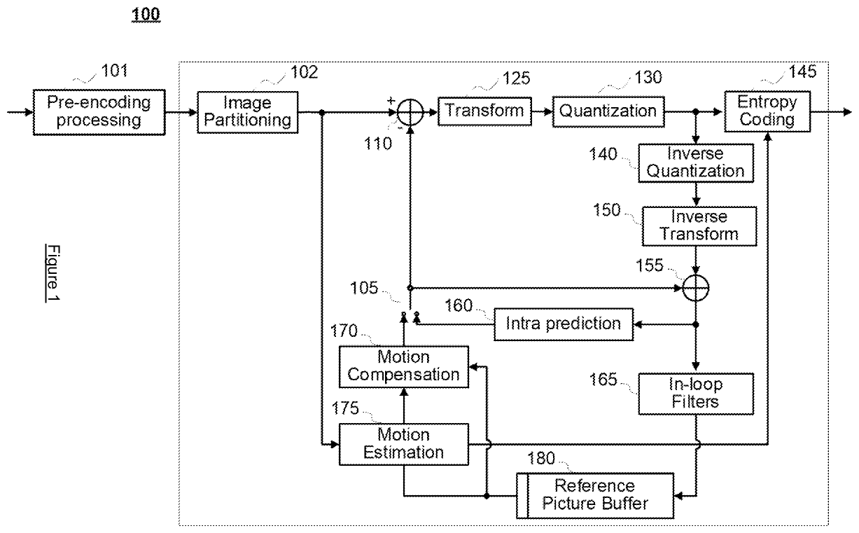

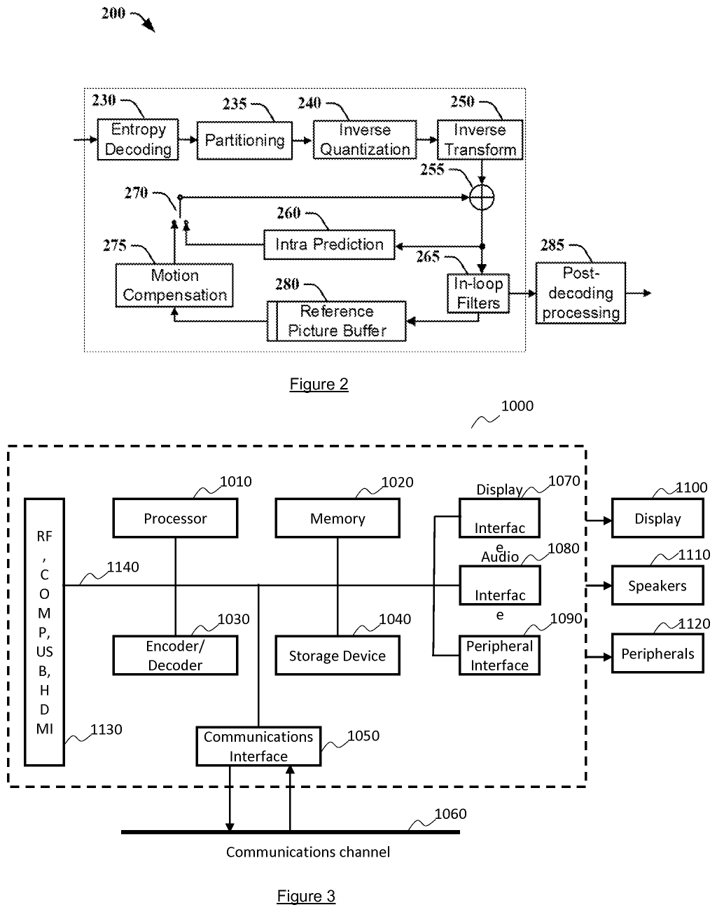

FIGS. 4a to 4c and FIGS. 5a to 5c, described above, illustrate exemplary embodiments, notably in the field of Deep Neural Network compression. However, some other aspects of the present disclosure can be implemented in other technical fields than neural network compression, for instance in technical fields involving processing of large volume of data. like video processing, as illustrated by FIGS. 1 and 2.

At least some embodiments relate to improving compression efficiency compared to existing video compression systems such as HEVC (HEVC refers to High Efficiency Video Coding, also known as H.265 and MPEG-H Part 2 described in “ITU-T H.265 Telecommunication standardization sector of ITU (10/2014), series H: audiovisual and multimedia systems, infrastructure of audiovisual services—coding of moving video, High efficiency video coding, Recommendation ITU-T H.265”), or compared to under development video compression systems such WC (Versatile Video Coding, a new standard being developed by JVET, the Joint Video Experts Team).

To achieve high compression efficiency, image and video coding schemes usually employ prediction, including spatial and/or motion vector prediction, and transforms to leverage spatial and temporal redundancy in the video content. Generally, intra or inter prediction is used to exploit the intra or inter frame correlation, then the differences between the original image and the predicted image, often denoted as prediction errors or prediction residuals, are transformed, quantized, and entropy coded. To reconstruct the video, the compressed data are decoded by inverse processes corresponding to the entropy coding, quantization, transform, and prediction. Mapping and inverse mapping processes can be used in an encoder and decoder to achieve improved coding performance. Indeed, for better coding efficiency, signal mapping may be used. Mapping aims at better exploiting the samples codewords values distribution of the video pictures.

FIG. 1 illustrates an encoder 100. Variations of this encoder 100 are contemplated, but the encoder 100 is described below for purposes of clarity without describing all expected variations. Before being encoded, the video sequence may go through pre-encoding processing (101), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing and attached to the bitstream.

In the encoder 100, a picture is encoded by the encoder elements as described below. The picture to be encoded is partitioned (102) and processed in units of, for example, CUs. Each unit is encoded using, for example, either an intra or inter mode. When a unit is encoded in an intra mode, it performs intra prediction (160). In an inter mode, motion estimation (175) and compensation (170) are performed. The encoder decides (105) which one of the intra mode or inter mode to use for encoding the unit, and indicates the intra/inter decision by, for example, a prediction mode flag. Prediction residuals are calculated, for example, by subtracting (110) the predicted block from the original image block.

The prediction residuals are then transformed (125) and quantized (130). The quantized transform coefficients, as well as motion vectors and other syntax elements, are entropy coded (145) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (140) and inverse transformed (150) to decode prediction residuals. Combining (155) the decoded prediction residuals and the predicted block, an image block is reconstructed. In-loop filters (165) are applied to the reconstructed picture to perform, for example, deblocking/SAO (Sample Adaptive Offset) filtering to reduce encoding artifacts. The filtered image is stored at a reference picture buffer (180).

FIG. 2 illustrates a block diagram of a video decoder 200. In the decoder 200, a bitstream is decoded by the decoder elements as described below. Video decoder 200 generally performs a decoding pass reciprocal to the encoding pass as described in FIG. 1. The encoder 100 also generally performs video decoding as part of encoding video data.

In particular, the input of the decoder includes a video bitstream, which can be generated by video encoder 100. The bitstream is first entropy decoded (230) to obtain transform coefficients, motion vectors, and other coded information. The picture partition information indicates how the picture is partitioned. The decoder may therefore divide (235) the picture according to the decoded picture partitioning information. The transform coefficients are de-quantized (240) and inverse transformed (250) to decode the prediction residuals. Combining (255) the decoded prediction residuals and the predicted block, an image block is reconstructed. The predicted block can be obtained (270) from intra prediction (260) or motion-compensated prediction (i.e., inter prediction) (275). In-loop filters (265) are applied to the reconstructed image. The filtered image is stored at a reference picture buffer (280).

The decoded picture can further go through post-decoding processing (285), for example, an inverse color transform (e.g. conversion from YCbCr 4:2:0 to RGB 4:4:4) or an inverse remapping performing the inverse of the remapping process performed in the pre-encoding processing (101).

The post-decoding processing can use metadata derived in the pre-encoding processing and signaled in the bitstream.

FIGS. 1 and 2 provide some embodiments, but other embodiments are contemplated and the discussion of FIGS. 1 and 2 and 3 does not limit the breadth of the implementations. At least one of the aspects generally relates to encoding and decoding (for instance, video encoding and decoding, and/or encoding and decoding of at least some weights of one or more layers of a DNN), and at least one other aspect generally relates to transmitting a bitstream generated or encoded. These and other aspects can be implemented as a method, an apparatus, a computer readable storage medium having stored thereon instructions for encoding or decoding data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably. Usually, but not necessarily, the term “reconstructed” is used at the encoder side while “decoded” is used at the decoder side.

Various methods are described herein, and each of the methods comprises one or more steps or actions for achieving the described method. Unless a specific order of steps or actions is required for proper operation of the method, the order and/or use of specific steps and/or actions may be modified or combined. Various methods and other aspects described in this application can be used to modify modules, for example, the intra prediction, entropy coding, and/or decoding modules (160, 260, 145, 230), of a video encoder 100 and decoder 200 as shown in FIG. 1 and FIG. 2. Moreover, the present aspects are not limited to VVC or HEVC, and can be applied, for example, to other standards and recommendations, whether pre-existing or future-developed, and extensions of any such standards and recommendations (including VVC and HEVC). Unless indicated otherwise, or technically precluded, the aspects described in this application can be used individually or in combination.

Various numeric values are used in the present application (for example regarding importance metric). The specific values are for example purposes and the aspects described are not limited to these specific values.

FIG. 3 illustrates a block diagram of an example of a system in which various aspects and embodiments are implemented. FIG. 3 provides some embodiments, but other embodiments are contemplated, and the discussion of FIG. 3 does not limit the breadth of the implementations.

System 1000 can be embodied as a device including the various components described below and is configured to perform one or more of the aspects described in this document. Examples of such devices include, but are not limited to, various electronic devices such as personal computers, laptop computers, smartphones, tablet computers, digital multimedia set top boxes, digital television receivers, personal video recording systems, connected home appliances, and servers. Elements of system 1000, singly or in combination, can be embodied in a single integrated circuit (IC), multiple ICs, and/or discrete components. For example, in at least one embodiment, the processing and encoder/decoder elements of system 1000 are distributed across multiple ICs and/or discrete components. In various embodiments, the system 1000 is communicatively coupled to one or more other systems, or other electronic devices, via, for example, a communications bus or through dedicated input and/or output ports. In various embodiments, the system 1000 is configured to implement one or more of the aspects described in this document.

The system 1000 includes at least one processor 1010 configured to execute instructions loaded therein for implementing, for example, the various aspects described in this document.

Processor 1010 can include embedded memory, input output interface, and various other circuitries as known in the art. The system 1000 includes at least one memory 1020 (e.g., a volatile memory device, and/or a non-volatile memory device). System 1000 includes a storage device 1040, which can include non-volatile memory and/or volatile memory, including, but not limited to, Electrically Erasable Programmable Read-Only Memory (EEPROM), Read-Only Memory (ROM),

Programmable Read-Only Memory (PROM), Random Access Memory (RAM), Dynamic Random-Access Memory (DRAM), Static Random-Access Memory (SRAM), flash, magnetic disk drive, and/or optical disk drive. The storage device 1040 can include an internal storage device, an attached storage device (including detachable and non-detachable storage devices), and/or a network accessible storage device, as non-limiting examples.

System 1000 includes an encoder/decoder module 1030 configured, for example, to process data to provide an encoded video or decoded video, and the encoder/decoder module 1030 can include its own processor and memory. The encoder/decoder module 1030 represents module(s) that can be included in a device to perform the encoding and/or decoding functions. As is known, a device can include one or both of the encoding and decoding modules. Additionally, encoder/decoder module 1030 can be implemented as a separate element of system 1000 or can be incorporated within processor 1010 as a combination of hardware and software as known to those skilled in the art.

Program code to be loaded onto processor 1010 or encoder/decoder 1030 to perform the various aspects described in this document can be stored in storage device 1040 and subsequently loaded onto memory 1020 for execution by processor 1010. In accordance with various embodiments, one or more of processor 1010, memory 1020, storage device 1040, and encoder/decoder module 1030 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 1010 and/or the encoder/decoder module 1030 is used to store instructions and to provide working memory for processing that is needed during encoding or decoding. In other embodiments, however, a memory external to the processing device (for example, the processing device can be either the processor 1010 or the encoder/decoder module 1030) is used for one or more of these functions. The external memory can be the memory 1020 and/or the storage device 1040, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 1000 can be provided through various input devices as indicated in block 1130. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 3, include composite video.

In various embodiments, the input devices of block 1130 have associated respective input processing elements as known in the art. For example, the RF portion can be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which can be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 1000 to other electronic devices across USB and/or HDMI connections. It is to be understood that various aspects of input processing, for example, Reed-Solomon error correction, can be implemented, for example, within a separate input processing IC or within processor 1010 as necessary. Similarly, aspects of USB or HDMI interface processing can be implemented within separate interface ICs or within processor 1010 as necessary. The demodulated, error corrected, and demultiplexed stream is provided to various processing elements, including, for example, processor 1010, and encoder/decoder 1030 operating in combination with the memory and storage elements to process the data stream as necessary for presentation on an output device.

Various elements of system 1000 can be provided within an integrated housing, Within the integrated housing, the various elements can be interconnected and transmit data therebetween using suitable connection arrangement 1140, for example, an internal bus as known in the art, including the Inter-IC (I2C) bus, wiring, and printed circuit boards.

The system 1000 includes communication interface 1050 that enables communication with other devices via communication channel 1060. The communication interface 1050 can include, but is not limited to, a transceiver configured to transmit and to receive data over communication channel 1060. The communication interface 1050 can include, but is not limited to, a modem or network card and the communication channel 1060 can be implemented, for example, within a wired and/or a wireless medium.

Data is streamed, or otherwise provided, to the system 1000, in various embodiments, using a wireless network such as a Wi-Fi network, for example IEEE 802.11 (IEEE refers to the Institute of Electrical and Electronics Engineers). The Wi-Fi signal of these embodiments is received over the communications channel 1060 and the communications interface 1050 which are adapted for Wi-Fi communications. The communications channel 1060 of these embodiments is typically connected to an access point or router that provides access to external networks including the Internet for allowing streaming applications and other over-the-top communications. Other embodiments provide streamed data to the system 1000 using a set-top box that delivers the data over the HDMI connection of the input block 1130. Still other embodiments provide streamed data to the system 1000 using the RF connection of the input block 1130. As indicated above, various embodiments provide data in a non-streaming manner. Additionally, various embodiments use wireless networks other than Wi-Fi, for example a cellular network or a Bluetooth network.

The system 1000 can provide an output signal to various output devices, including a display 1100, speakers 1110, and other peripheral devices 1120. The display 1100 of various embodiments includes one or more of, for example, a touchscreen display, an organic light-emitting diode (OLED) display, a curved display, and/or a foldable display. The display 1100 can be for a television, a tablet, a laptop, a cell phone (mobile phone), or another device. The display 1100 can also be integrated with other components (for example, as in a smart phone), or separate (for example, an external monitor for a laptop). The other peripheral devices 1120 include, in various examples of embodiments, one or more of a stand-alone digital video disc (or digital versatile disc) (DVR, for both terms), a disk player, a stereo system, and/or a lighting system. Various embodiments use one or more peripheral devices 1120 that provide a function based on the output of the system 1000. For example, a disk player performs the function of playing the output of the system 1000.

In various embodiments, control signals are communicated between the system 1000 and the display 1100, speakers 1110, or other peripheral devices 1120 using signaling such as AV. Link, Consumer Electronics Control (CEC), or other communications protocols that enable device-to-device control with or without user intervention. The output devices can be communicatively coupled to system 1000 via dedicated connections through respective interfaces 1070, 1080, and 1090. Alternatively, the output devices can be connected to system 1000 using the communications channel 1060 via the communications interface 1050. The display 1100 and speakers 1110 can be integrated in a single unit with the other components of system 1000 in an electronic device such as, for example, a television. In various embodiments, the display interface 1070 includes a display driver, such as, for example, a timing controller (T Con) chip.

The display 1100 and speaker 1110 can alternatively be separate from one or more of the other components, for example, if the RF portion of input 1130 is part of a separate set-top box. In various embodiments in which the display 1100 and speakers 1110 are external components, the output signal can be provided via dedicated output connections, including, for example, HDMI ports, USB ports, or COMP outputs.

The embodiments can be carried out by computer software implemented by the processor 1010 or by hardware, or by a combination of hardware and software. As a non-limiting example, the embodiments can be implemented by one or more integrated circuits. The memory 1020 can be of any type appropriate to the technical environment and can be implemented using any appropriate data storage technology, such as optical memory devices, magnetic memory devices, semiconductor-based memory devices, fixed memory, and removable memory, as non-limiting examples. The processor 1010 can be of any type appropriate to the technical environment, and can encompass one or more of microprocessors, general purpose computers, special purpose computers, and processors based on a multi-core architecture, as non-limiting examples.

Various implementations involve decoding. “Decoding”, as used in this application, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application.

As further examples, in one embodiment “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that the syntax elements as used herein, are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Various embodiments refer to parametric models or rate distortion optimization. In particular, during the encoding process, the balance or trade-off between the rate and distortion is usually considered, often given the constraints of computational complexity. It can be measured through a Rate Distortion Optimization (RDO) metric, or through Least Mean Square (LMS), Mean of Absolute Errors (MAE), or other such measurements. The rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals at least one of a plurality of transforms, coding modes or flags. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

We describe a number of embodiments. Features of these embodiments can be provided alone or in any combination, across various claim categories and types. Further, embodiments can include one or more of the following features, devices, or aspects, alone or in any combination, across various claim categories and types:

A process or device to perform encoding and decoding with deep neural network compression of a pre-trained deep neural network.

A process or device to perform encoding and decoding with inserted information in a bitstream representative of parameters to implement deep neural network compression of a pre-trained deep neural network comprising one or more layers.

A process or device to perform encoding and decoding with inserted information in a bitstream representative of parameters to implement deep neural network compression of a pre-trained deep neural network until a compression criterion is reached.

A bitstream or signal that includes one or more of the described syntax elements, or variations thereof.

A bitstream or signal that includes syntax conveying information generated according to any of the embodiments described.

Creating and/or transmitting and/or receiving and/or decoding according to any of the embodiments described.

A method, process, apparatus, medium storing instructions, medium storing data, or signal according to any of the embodiments described.

Inserting in the signaling syntax elements that enable the decoder to determine coding mode in a manner corresponding to that used by an encoder.

Creating and/or transmitting and/or receiving and/or decoding a bitstream or signal that includes one or more of the described syntax elements, or variations thereof.

A TV, set-top box, cell phone, tablet, or other electronic device that performs transform method(s) according to any of the embodiments described.

A TV, set-top box, cell phone, tablet, or other electronic device that performs transform method(s) determination according to any of the embodiments described, and that displays (e.g. using a monitor, screen, or other type of display) a resulting image.

A TV, set-top box, cell phone, tablet, or other electronic device that selects, bandlimits, or tunes (e.g. using a tuner) a channel to receive a signal including an encoded image, and performs transform method(s) according to any of the embodiments described.

A TV, set-top box, cell phone, tablet, or other electronic device that receives (e.g. using an antenna) a signal over the air that includes an encoded image, and performs transform method(s).

As can be appreciated by one skilled in the art, aspects of the present principles can be embodied as a system, device, method, signal or computer readable product or medium.

The present disclosure for instance relates to a method, implemented in an electronic device, the method comprising encoding a data set in a signal, said encoding comprising quantizing said data set by using a codebook obtained by clustering said data set, said clustering taking account of a probability of appearance of data in said dataset; said probability being bounded to at least one bounding value.

According to at least one embodiment of the present disclosure, said at least one bounding value depends from a distribution of said data in said data set.

According to at least one embodiment of the present disclosure, said at least one bounding value depends from at least one peak value of said distribution.

According to at least one embodiment of the present disclosure, data of said dataset having a probability of appearance smaller than a first of said at least one bounding value are clustered using said first bounding value.

According to at least one embodiment of the present disclosure, said first bounding value is less or equal to 10 per cent of at least one peak value of a distribution of said data in said data set.

According to at least one embodiment of the present disclosure, said data set comprises at least one first weight of at least one layer of at least one Deep Neural Network and said quantizing outputs said codebook and index values for said at least one first weight of said at least one layer.

According to at least one embodiment of the present disclosure, said clustering further takes into account an impact of a modification of at least one second of said weights on an accuracy of said Deep Neural Network.

According to at least one embodiment of the present disclosure, said clustering takes into account impacts of weights populating at least one cluster for centering said cluster.

According to at least one embodiment of the present disclosure, said Deep Neural Network is a pre-trained Deep Neural Network trained using a training dataset and said impact is computed using at least a part of said training set.

According to at least one embodiment of the present disclosure, said impact is computed as a ratio of changes of a value of a loss function used for training said Deep Neural Network according to said modification of said second weight value.

According to at least one embodiment of the present disclosure, the method comprises :

unbalancing said codebook, by moving at least one weight of at least one first of said clusters to one second of said clusters,

entropy coding said first weight, using said unbalanced codebook.

According to at least one embodiment of the present disclosure, said moved weight of said first cluster has an impact lower than a first impact value. According to at least one embodiment of the present disclosure, said second cluster is a neighboring cluster of said first cluster.

According to at least one embodiment of the present disclosure, said second cluster is the n-closest neighboring cluster of said first cluster, including said cluster, having the highest population.

According to at least one embodiment of the present disclosure, said method comprises coding in said signal the codebook used for encoding said first weight.

The present disclosure further relates to a device comprising at least one processor configured for encoding a data set in a signal, said encoding comprising quantizing said data set by using a codebook obtained by clustering said data set, said clustering taking account of a probability of appearance of data in said dataset; said probability being bounded to at least one bounding value.

While not explicitly described, the above device of the present disclosure can be adapted to perform the above method of the present disclosure in any of its embodiments.

The present disclosure further relates to a method comprising decoding a data set in a signal, said data set being obtained by the above encoding method of the present disclosure in any of its embodiments.

For instance, the present disclosure further relates to a method comprising decoding a data set in a signal, said decoding comprising an inverse quantizing using a codebook obtained by clustering said data set, said clustering taking account of a probability of appearance of data in said dataset, said probability being bounded to at least one bounding value.

The present disclosure further relates to a device comprising at least one processor configured for decoding a data set in a signal, said data set being obtained by the above encoding method of the present disclosure in any of its embodiments.

For instance, the present disclosure further relates to a device comprising at least one processor configured for decoding a data set in a signal, said decoding comprising an inverse quantizing using a codebook obtained by clustering said data set, said clustering taking account of a probability of appearance of data in said dataset, said probability being bounded to at least one bounding value.

The present disclosure further relates to a method comprising encoding in a signal at least one first weight of at least one layer of at least one Deep Neural Network, said encoding taking into account an impact of a modification of at least one second of said weights on an accuracy of said Deep Neural Network.

According to at least one embodiment of the present disclosure, said encoding comprises a clustering-based quantizing and wherein said clustering is performed by taking into account said impact of said at least one second weight.

According to at least one embodiment of the present disclosure, said clustering takes into account impacts of weights populating at least one cluster for centering said cluster.

According to at least one embodiment of the present disclosure, said Deep Neural Network is a pre-trained Deep Neural Network trained using a training dataset and said impact is computed using at least a part of said training set.

According to at least one embodiment of the present disclosure, said impact is computed as a ratio of changes of a value of a loss function used for training said Deep Neural Network according to said modification of said second weight value.

According to at least one embodiment of the present disclosure, said method comprises:
unbalancing said codebook, by moving at least one weight of at least one first of said clusters to one second of said clusters,
entropy coding said first weight, using said unbalanced codebook.

According to at least one embodiment of the present disclosure, said moved weight of said first cluster has an impact lower than a first impact value.

According to at least one embodiment of the present disclosure, said second cluster is a neighboring cluster of said first cluster.

According to at least one embodiment of the present disclosure, said second cluster is the n-closest neighboring cluster of said first cluster, including said cluster, having the highest population.

According to at least one embodiment of the present disclosure, said method comprises coding in said signal the codebook used for encoding said first weight.

The present disclosure further relates to a device comprising at least one processor configured for encoding in a signal at least one first weight of at least one layer of at least one Deep Neural Network, said encoding taking into account an impact of a modification of at least one second of said weights on an accuracy of said Deep Neural Network. While not explicitly described, the above device of the present disclosure can be adapted to perform the above method of the present disclosure in any of its embodiments.

The present disclosure further relates to a method comprising decoding at least one first weight of at least one layer of at least one Deep Neural Network; wherein said first weight has been encoded using the above encoding method of the present disclosure in any of its embodiments. For instance, the present disclosure further relates to a method comprising decoding at least one first weight of at least one layer of at least one Deep Neural Network; wherein said first weight has been encoded by taking into account an impact of a modification of at least one second of said weights on an accuracy of said Deep Neural Network.

The present disclosure further relates to a device comprising at least one processor configured for decoding at least one first weight of at least one layer of at least one Deep Neural Network; wherein said first weight has been encoded using the above encoding method of the present disclosure in any of its embodiments. While not explicitly described, the present embodiments related to the methods or to the corresponding electronic devices can be employed in any combination or sub-combination.

The present disclosure further relates to a signal carrying a data set coded using a method, implemented in an electronic device, the method comprising encoding a data set in a signal, said encoding comprising quantizing said data set by using a codebook obtained by clustering said data set, said clustering taking account of a probability of appearance of data in said dataset; said probability being bounded to at least one bounding value.

The present disclosure further relates to a signal carrying a data set coded using a method, implemented in an electronic device, the method comprising encoding in a signal at least one first weight of at least one layer of at least one Deep Neural Network, said encoding taking into account an impact of a modification of at least one second of said weights on an accuracy of said Deep Neural Network.

According to another aspect, the present disclosure relates to a non-transitory program storage device, readable by a computer, tangibly embodying a program of instructions executable by the computer to perform at least one of the methods of the present disclosure, in any of its embodiments. For instance, at least one embodiment of the present disclosure relates to non-transitory program storage device, readable by a computer, tangibly embodying a program of instructions executable by the computer to perform a method, implemented in an electronic device, the method comprising encoding a data set in a signal, said encoding comprising quantizing said data set by using a codebook obtained by clustering said data set, said clustering taking account of a probability of appearance of data in said dataset; said probability being bounded to at least one bounding value. At least one embodiment of the present disclosure relates, for instance, to non-transitory program storage device, readable by a computer, tangibly embodying a program of instructions executable by the computer to perform a method, implemented in an electronic device, the method comprising encoding in a signal at least one first weight of at least one layer of at least one Deep Neural Network, said encoding taking into account an impact of a modification of at least one second of said weights on an accuracy of said Deep Neural Network. For instance, at least one embodiment of the present disclosure relates to non-transitory program storage device, readable by a computer, tangibly embodying a program of instructions executable by the computer to perform a method, implemented in an electronic device, the method comprising decoding a data set in a signal, said decoding comprising an inverse quantizing using a codebook obtained by clustering said data set, said clustering taking account of a probability of appearance of data in said dataset, said probability being bounded to at least one bounding value. For instance, at least one embodiment of the present disclosure relates to non-transitory program storage device, readable by a computer, tangibly embodying a program of instructions executable by the computer to perform a method, implemented in an electronic device, the method comprising decoding at least one first weight of at least one layer of at least one Deep Neural Network; said first weight has been encoded by taking into account an impact of a modification of at least one second of said weights on an accuracy of said Deep Neural Network.

According to another aspect, the present disclosure relates to a storage medium comprising instructions which when executed by a computer cause the computer to carry out at least one of the methods of the present disclosure, in any of its embodiments. For instance, at least one embodiment of the present disclosure relates to a storage medium comprising instructions which when executed by a computer cause the computer to carry out a method, implemented in an electronic device, the method comprising encoding a data set in a signal, said encoding comprising quantizing said data set by using a codebook obtained by clustering said data set, said clustering taking account of a probability of appearance of data in said dataset; said probability being bounded to at least one bounding value. For instance, at least one embodiment of the present disclosure relates to a storage medium comprising instructions which when executed by a computer cause the computer to carry out a method, implemented in an electronic device, the method comprising encoding in a signal at least one first weight of at least one layer of at least one Deep Neural Network, said encoding taking into account an impact of a modification of at least one second of said weights on an accuracy of said Deep Neural Network.For instance, at least one embodiment of the present disclosure relates to a storage medium comprising instructions which when executed by a computer cause the computer to carry out a method, implemented in an electronic device, the method comprising decoding a data set in a signal, said decoding comprising an inverse quantizing using a codebook obtained by clustering said data set, said clustering taking account of a probability of appearance of data in said dataset, said probability being bounded to at least one bounding value. For instance, at least one embodiment of the present disclosure relates to a storage medium comprising instructions which when executed by a computer cause the computer to carry out a method, implemented in an electronic device, the method comprising decoding at least one first weight of at least one layer of at least one Deep Neural Network, wherein said first weight has been encoded by taking into account an impact of a modification of at least one second of said weights on an accuracy of said Deep Neural Network.

1. A device comprising at least one processor configured for:
quantizing a data set using a codebook obtained by clustering said data set;
modifying a probability density function of said dataset by, for at least one probability of appearance of data in said dataset that is lower than a first bounding value, setting said probability of appearance to said bounding value, and
clustering said data set using said modified probability density function.

2. A method comprising:
quantizing a data set using a codebook obtained by clustering said data set;
modifying, a probability density function of said dataset by, for at least one probability of appearance of data in said dataset that is lower than a first bounding value, setting said probability of appearance to said bounding value; and
clustering said data set using said modified probability density function.

3-5. (canceled)

6. The device of claim 1 wherein said first bounding value is less than or equal to 10 per-cent of at least one peak value of a distribution of said data in said data set.

7. The device of claim 1, wherein said data set comprises at least one first weight of at least one layer of at least one deep neural nework and said quantizing outputs said codebook and index values for said at least one first weight of said at least one layer.

8.-10. (canceled)

11. The device of claim 7 wherein said clustering is performed by taking into account an impact of a modifiation of at least one second weight on an accuracy of said at least one deep neural network.

12. The device claim 7, wherein said clustering takes into account impacts of weights populating at least one cluster for centering said cluster.

13. The device of claim 7, wherein said at least one deep neural network is a pre-trained deep tissue network trained using a training dataset and wherein said impact is computed using at least a part of said training set.

14. The device of claim 11, wherein said impact is computed as a ratio of changes of a value of a loss function used for training said at least one deep neural network according to said modification of said second weight.

15. The device of claim 7, said at least one processor being further configured for:
unbalancing said codebook, by moving at least one weight of a first cluster to a second cluster; and
entropy coding said at least one first weight, using said unbalanced codebook.

16. (canceled)

17. The device of claim 15 wherein said second cluster is a neighboring cluster of said first cluster.

18. The device of claim 17 wherein said second cluster is the n-closest neighboring cluster of said first cluster, including said cluster, having the highest population.

19.-25. (canceled)

26. A computer readable storage medium comprising instructions which when executed by a computer cause the computer to carry out the method of claim 2.

27. The method of claim 2, wherein said data set comprises at least one first weight of at least one layer of at least one deep neural network and said quantizing outputs said codebook and index values for said at least one first weight of said at least one layer.

28. The method of claim 27, wherein said clustering is performed by taking into account an impact of a modification of at least one second weight on an accuracy of said at least one deep neural network.

29. The method of claim 27, wherein said clustering takes into account impacts of weights populating at least one cluster for centering said cluster.

30. The method of claim 27, wherein said at least one deep neural network is a pre-trained deep neural network trained using a training dataset and wherein said impact is computed using at least a part of said training set.

31. The method of claim 7, wherein said impact is computed as a ratio of changes of a value of a loss function used for training said at least one deep neural network according to said modification of said second weight.

32. The method of claim 7, further comprising:
unbalancing said codebook, by moving at least one weight of a first cluster to a second cluster; and
entropy coding said at least one first weight, using said unbalanced codebook.

33. The method of claim 32, wherein said second cluster is a neighboring cluster of said first cluster.

34. The method of claim 33, wherein said second cluster is the n-closest neighboring cluster of said first cluster, including said cluster, having the highest population.
